(19) United States
(12) Patent Application Publication
(10) Pub. No.: US 2007/0029290 A1
(43) Pub. Date: Feb. 8, 2007

(54) Method for the plasma, laser or electron beam welding of identical or different materials with a tendency for excessive hardening, with copper or a copper alloy as a filler material

(75) Inventor: Oskar Kehrer, Graz (AT)

Correspondence Address: HARNESS, DICKEY & PIERCE, P.L.C., P.O. BOX 828, BLOOMFIELD HILLS, MI, 48303, US

(73) Assignee: MAGNA DRIVETRAIN AG & CO KG, Lannach (AT)

(21) Appl. No.: 11/396,136

(22) Filed: Mar. 31, 2006

Related U.S. Application Data
(63) Continuation of application No. PCT/AT04/00326, filed on Sep. 28, 2004.

(30) Foreign Application Priority Data
Oct. 2, 2003 (AT) GM 676/2003

(51) Int. Cl. B23K 15/00; B23K 10/02; B23K 26/20; B23K 103/12

(52) U.S. Cl. 219/121.14; 219/121.64; 219/121.46

(57) ABSTRACT

A method for welding identical or different materials with a tendency for excessive hardening. The method uses a high-energy beam to melt, in a weld seam, copper or an alloy having a high copper content and a basic material or materials such as cast iron, cast steel, malleable iron, sintered material, case-hardened steel, steel with a high C content, annealed steel, high-strength steel, and the like. The use of copper provides a weld with a lower melting point.

The invention relates to a method for welding identical or different materials with a tendency for excessive hardening such as cast iron, cast steel, malleable iron, sintered material, case-hardened steel, steel with a high C content, annealed steel, high-strength steel etc., said method using a high-energy beam, as well as to an application of the method and to machine parts welded according to said method.

A process for connecting a cast part with a part made of case-hardened steel by means of a high-energy beam is known from AT 003253 U1. Using this known process, it is possible to connect components made up of different and partially finished and/or already hardened parts by welding, for example components which are used in drive chains of motor vehicles. Thus, it is possible to connect a finish-machined and hardened toothed wheel with a hollow casing part designed as a cast part, wherein the toothed wheel can also be case-hardened and the cast part can be formed from cast steel, white-malleable iron or spheroidal graphite iron. In this way, it is possible to design such parts in a space- and weight-saving manner, particularly since the high-strength screws which so far have been provided for the connection of such parts and the flanges receiving the same can be omitted.

Welding of the above-described parts always involves the risk that a large heat input and hence a distortion of the parts to be connected will occur as a result of the high temperature of the melt formed during welding—that is, of the remelted material formed from material of the parts to be welded together and of a welding filler. Another difficulty can arise if the viscosity of the melt is too high, i.e., if the melt is too viscous, resulting in only low welding speeds, which affects not only the heat input but also the economic efficiency.

The invention aims at avoiding the above-described disadvantages and difficulties and has as its object to provide a method of the initially described kind, by means of which it is possible to interconnect also very delicate components which are required to still exhibit a very high accuracy after welding, such as, for instance, parts which do not allow any dislocation of the contact pattern of a toothed wheel work, involving the smallest possible heat affected zone and high economic efficiency so that the method can be used advantageously also for mass production.

According to the invention, said object is achieved in that copper or an alloy having a high copper content as well as material of the basic material or the basic materials, respectively, to be welded defining the weld seam are melted in the weld seam by means of the high-energy beam and the basic material or the basic materials, respectively, is/are welded, whereby the melt formed is solidified. Providing copper or an alloy having a high copper content, respectively, in the weld seam causes the formation of a melt in the weld seam which has a melting point that is much lower compared to the prior art, with the melting point, for example, being reduced by one third in comparison to a steel melt.

The result is a lower heat input and hence a smaller distortion in comparison to weld seams with a steel melt. In addition, the melt comprising copper is thinner, opening up the possibility to operate with very high welding speeds which exceed the previously known welding speeds. The welding time is reduced to one half and less compared to the prior art. If the parts to be connected have interlockings, said interlockings do not have to be corrected after the method according to the invention has been carried out. In addition, high impulsive moments are transmittable for parts connected according to the invention.

Preferably, the alloy melted in the weld seam and having a high copper content has a minimum content of copper of 38%.

It is possible to provide, i.e. to insert, the copper in the weld seam in various ways. According to a first variant, the copper or the copper-bearing alloy, respectively, which is melted is inserted into the weld seam in the form of an auxiliary wire supplied during welding.

However, according to a preferred method, the copper or the copper-bearing alloy, respectively, can also be inserted into the weld seam prior to welding, such as by plating, rolling, spraying, inserting a moulded body etc.

Another variant is characterized in that the copper in the weld seam is applied chemically or galvanically prior to welding, optionally with additions of other alloy elements such as Sn and/or Zn.

Various advantageous compositions of the weld seam are specified in sub claims 6 to 22.

Advantageously, a plasma beam or a laser beam or an electron beam can be used as a high-energy beam, wherein the use of a plasma beam or of an electron beam has the advantage that the formation of splashes is avoided, whereby a covering of finished surfaces such as tooth flanks etc. is rendered superfluous.

The method according to the invention can advantageously be applied to machine parts, with at least one of said parts being manufactured from one of the materials indicated in claim 1 and with the machine parts already being finished.

One advantage of using the method according to the invention for connecting two parts forming a machine part is that edge preparation can be omitted, that is, additional processing such as, for example, the removal (peeling off) of a carburized case is not necessary.

A particularly suitable application of the method according to the invention is provided for parts of a drive chain of an all-terrain and/or road vehicle, especially for machine parts of such a drive chain which are provided with a toothed wheel work.

The invention also refers to a machine part formed from at least two parts welded together, wherein the weld seam has been formed as per the method according to the invention. Such a weld seam having a high copper content, preferably more than 38%, has a cross-section dimension smaller than 10 mm×1.5 mm, preferably smaller than 6 mm×0.8 mm. By “weld seam” is understood the remelted material formed from the parts to be welded together and the welding filler. It has been shown that parts welded by a laser beam or an electron beam exhibit a weld seam of a maximum width of 1 mm, whereas a plasma beam forms weld seams of up to at most 1.5 mm.

Preferably, the two parts to be welded together are supported against each other with at least one locating surface so that it is unnecessary to specifically align the parts during the welding process.

As already mentioned above, at least one of the parts can be provided with finished precision surfaces such as an interlocking prior to welding.

The invention is illustrated in further detail below by way of several exemplary embodiments illustrated in the drawing.

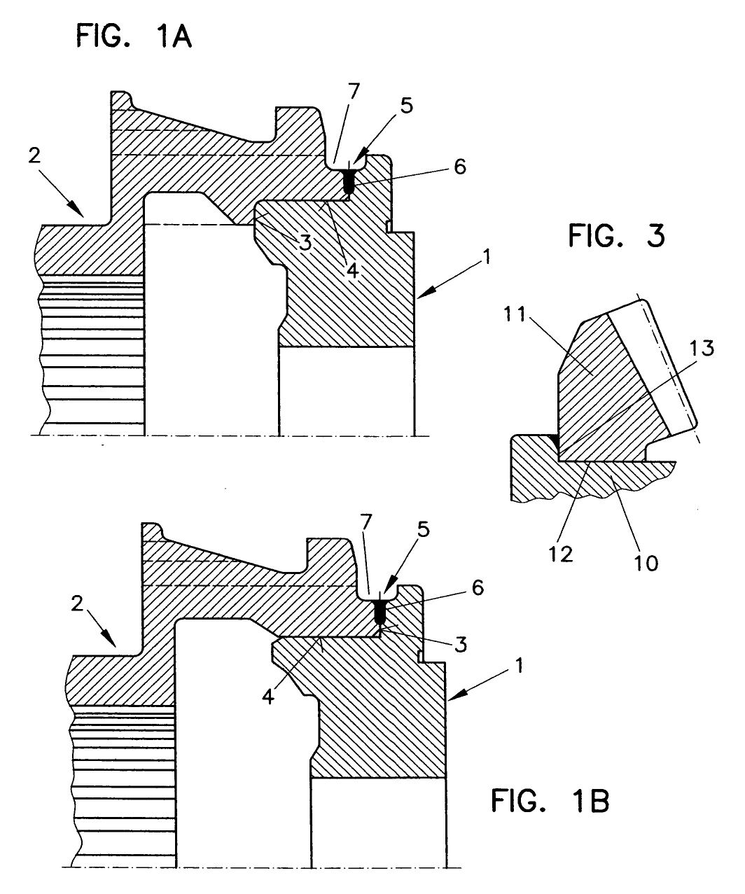

FIGS. 1A, 1B, 3 and 5 illustrated in the drawing show sectional views of machine parts which are to be connected by a weld seam, and

FIGS. 2, 4 and 6 show micrographs of the respective weld seams associated with these machine parts.

For the three exemplary embodiments described below, a laser welding plant with the following characteristics was used: radiation source Rofin Sinar 860 HF with a radiant power of 6 kW; CO₂ laser RF excited, laser head with rotational swivelling axis, crossjet and integrated wire feed unit; control Sinumerik 840 D, focal distances of focussing mirror ranging between 150 and 300 mm (preferably: 250 mm focal distance). If a 1.0 mm solid wire made of Cu is used, the ratio of wire feed speed to welding speed is, according to the invention, between 0.8:1 and 3:1, a preferred range thereof is from 1:1 to 2:1, a particularly suitable adjustment is the ratio 1.5:1, which was chosen for the exemplary embodiments.

All exemplary embodiments described below refer to connections on drive chains for motor vehicles. The required welding depths result in each case from the height of the torque to be transmitted and from the diameter on which the weld connection is provided. Common welding depths range between 1.5 and 8 mm, preferably between 3 and 5 mm. The energy inputs per unit length resulting therefrom produce a range of between 0.5 and 4 kJ/cm, a preferred range is from 0.7 to 2 kJ/cm, an optimum value is 1.

According to the exemplary embodiment illustrated in FIGS. 1A, 1B, a differential casing 1 is to be welded to a clutch basket 2 to form a unit. The differential casing 1 is formed from cast iron with spheroidal graphite GJS-500-7, the clutch basket 2 is manufactured from quenched and tempered steel 40 NiCrMo 22 quenched and tempered to 1100 N/mm², is hardened and tempered.

According to FIG. 1A, the two parts 1, 2 are supported against each other by means of two pairs of locating surfaces 3, 4, namely by means of a radially oriented pair 3 and a cylindrically shaped pair 4. The region 5 provided for the weld seam extends radially outwards from the pair of cylindrical locating surfaces 4.

According to the exemplary embodiment illustrated in FIG. 1B, a radial locating surface 3 is arranged below, i.e. radially to the inside of the weld seam to be provided, i.e. of region 5.

Edge preparation was carried out in both cases, i.e., a U-shaped cavity 6 similar to a bell seam, having a narrow cross-section and extending radially around the circumference of the parts was provided for the weld, whereby the radially external edges 7 were chamfered.

Welding was performed with a copper welding wire of a thickness of 1 mm being supplied, involving an energy input per unit length of 0.9 kJ/cm at a welding depth of 3.64 mm. The chemical composition of the copper wire was as follows: Sn=1.5%, Mn=1.5%, Fe=0.5%, Si=4%, Al=0.01%, Pb=0.02%, remainder=Cu.

FIG. 2 shows a metallographic traverse section through the weld seam 8 according to the embodiment illustrated in FIG. 1A, wherein the depth of the weld seam is dimensioned; it amounts to 3.64 mm. It is possible to discern the extremely narrow weld seam 8 and the also very narrow heat affected zone 9.

FIG. 3 shows a differential casing 10 prepared for being welded to a ring gear 11. The differential casing 10 is formed from spheroidal graphite GJS-600-3, the ring gear 11 is manufactured from case-hardened steel 20 MnCr 5.

The ring gear 11 rests with a cylindrical 12 and a radial 13 centering or locating surface, respectively, on the differential casing 10; except for a common edge chamfer, no special seam preparation was provided. The surface 13 of the ring gear 11 on which welding takes place, i.e., the radially extending surface 13, was not covered during carburization and, furthermore, the case was not removed prior to welding.

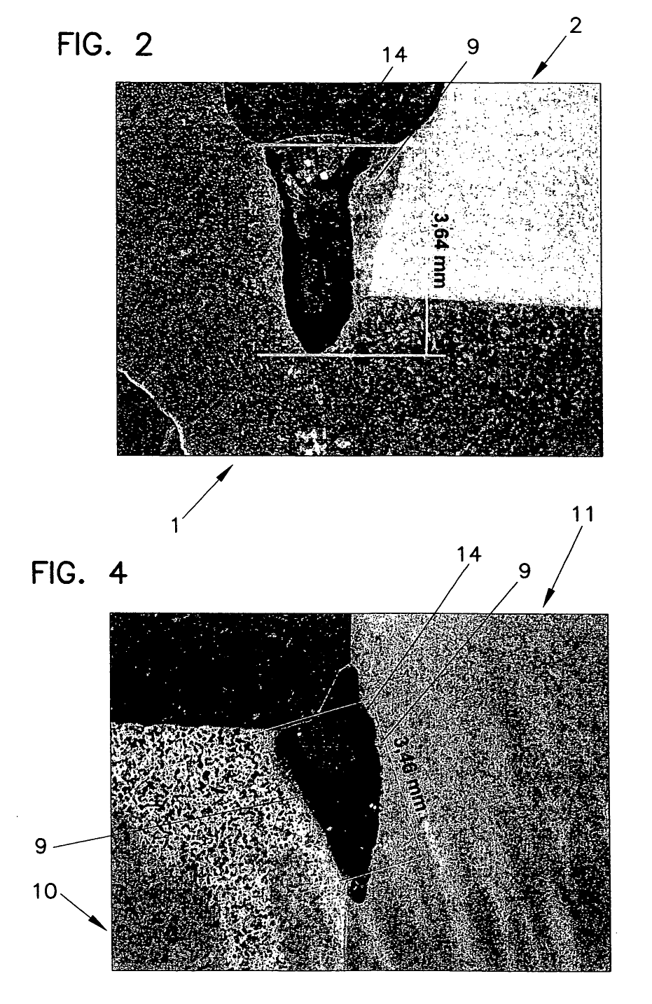

It can be seen in FIG. 4, the metallographic traverse section, that, also in this case, only a very small heat affected zone 9 was formed. At the upper edge of the weld seam 8, a characteristic region 14 of residual melt which solidified last can be seen clearly—just like in FIG. 2. Welding was effected with an energy input per unit length of 1 kJ/cm at a welding depth of 4.5 mm, with a copper wire having a diameter of 1 mm and the following chemical composition being supplied: Al=9.8%, Fe=1.1%, remainder=Cu.

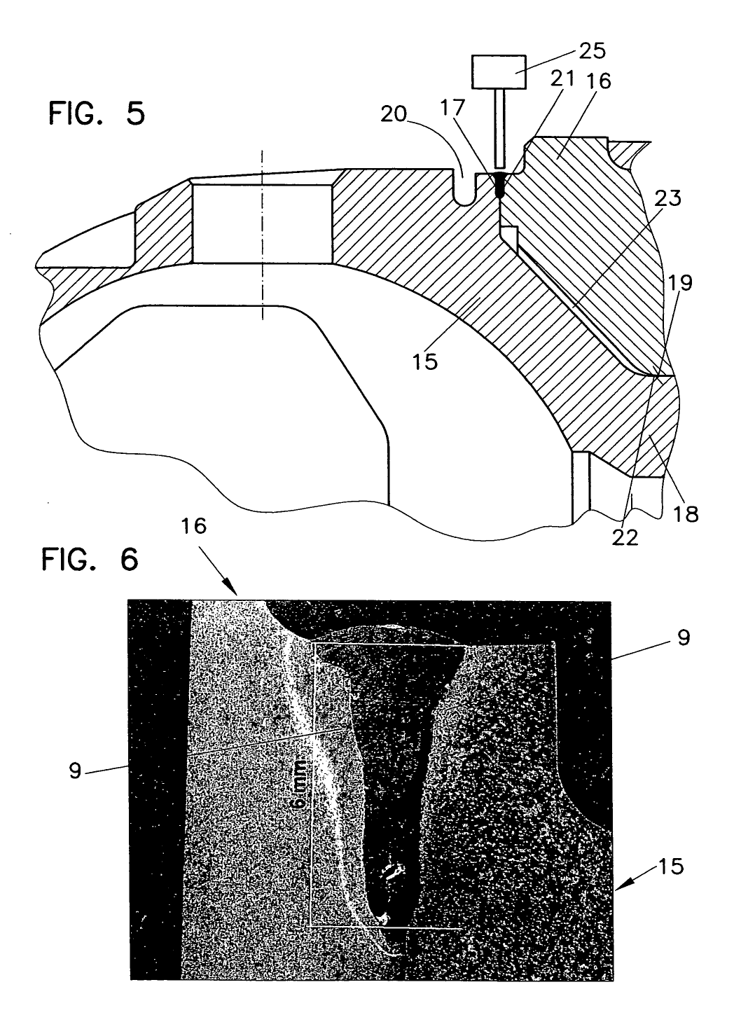

FIG. 5 shows a compensating gearbox casing 15 made of cast iron with spheroidal graphite GJG-500-7 to which a toothed wheel 16 made of case-hardened steel 18 CrNiMo 7-6 is to be welded. The casing 15 comprises a first axially normal surface 17 to be welded to which a cylindrical collar 18 forming an external cylindrical locating surface 19 is attached. In a spot of greater wall thickness, the casing can be provided with a circumferential groove 20 having a rounded cross-section and running in parallel to the first surface to be welded.

On the toothed wheel 16, a second surface 21 to be welded, positioned normally on a plane relative to the axis, and a cylindrical locating surface 22 placed on the cylindrical locating surface 19 of the casing 15 are provided. An enlargement 23 is provided between the cylindrical locating surfaces 19 and 22 and the surfaces 17 and 21 to be welded. The axis of rotation of the casing is indicated by 24, and the welding head is indicated by 25.

Welding was effected in the blank-hardened base material; the case was removed by hard machining. Edge preparation similar to that of FIGS. 1A and 1B was carried out. Welding was effected with an energy input per unit length of 1.3 kJ/cm at a welding depth of about 6 mm. The chemical composition of the filler material was as follows: Sn=1.2%, Mn=1.8%, Fe=0.8%, Si=3.3%, traces of Ag, remainder=Cu. The metallographic traverse section can be seen in FIG. 6.

It is possible to discern a very small heat affected zone also in this case. The welding depth amounts to 6 mm.

The method according to the invention has versatile applications. Various welding preparations are conceivable, for example:
butt joint,
V preparation,
U preparation,
HV preparation,
HU preparation,
combination of the above preparations,
only a common edge chamfer for joining (pressing on) the two parts to be welded=“no” seam preparation,
a different gap (surfaces to be welded do not fully abut).

Thereby, in the event of case hardening, the case can remain completely, can be worked off partially or completely, or the surface to be welded is covered from the outset in order to block carburization (mechanically with a ring, by the frame carrier, by pastes, by electroplating such as copperplating or the like).

In doing so, the weld seam can end up lying axially, radially or diagonally, depending on the respective structural solution.

The copper-bearing intermediate layer can be provided either galvanically, electrochemically, by spraying, mechanically by rolling, pressing on, clamping, inserting/adding, by pressing on prior to the welding process or by supplying an auxiliary wire/auxiliary powder during the welding process.

The method according to the invention allows the welding of materials which usually cause excessive hardening during welding. Instead of a case-hardened steel, a sintered steel (minimum thickness 6.6 g/cm³) hardened by the sintering heat and quenched by high-pressure gas can likewise be welded. With a carbon content of from 0.6 to 0.9% (e.g. FLC-4608 or FLNC-4408), it is not necessary to carburize said steel. Typical ranges of the alloy elements of sintered steels: Fe=89.15 to 97.75%; C=0.6 to 0.9%; Ni=0 to 7%; Mo=0.39 to 1.7%; Cu=0 to 3%. Likewise, phosphate coatings of the surface, which are often used in drive trains, do in no way interfere with the welding process according to the invention.

1. A method for welding identical or different materials with a tendency for excessive hardening such as cast iron, cast steel, malleable iron, sintered material, case-hardened steel, steel with a high C content, annealed steel, high-strength steel etc. said method using a high-energy beam, characterized in that copper or an alloy having a high copper content as well as material of the basic material or the basic materials, respectively, to be welded defining the weld seam are melted in the weld seam by means of the high-energy beam and the basic material or the basic materials, respectively, is/are welded, whereby the melt formed is solidified.

2. The method according to claim 1, characterized in that the alloy melted in the weld seam and having a high copper content has a minimum content of copper of 38%.

3. The method according to claim 1, characterized in that the copper or the copper-bearing alloy, respectively, which is melted is inserted into the weld seam in the form of an auxiliary wire supplied during welding.

4. The method according to claim 1, characterized in that the copper or the copper-bearing alloy, respectively, is inserted into the weld seam prior to welding, such as by plating, rolling, spraying, inserting a moulded body etc.

5. The method according to claim 1, characterized in that the copper in the weld seam is applied chemically or galvanically prior to welding, optionally with additions of other alloy elements such as Sn and/or Zn.

6. The method according to claim 5, characterized by 55-70% Cu, remainder Zn and optionally impurities.

7. The method according to claim 5, characterized by 80-86% Cu, remainder Sn and optionally impurities.

8. The method according to claim 1, characterized in that the melting point of the copper alloy inserted into the weld seam is in a range of between 950° and 1,150° C.

9. The method according to claim 1, characterized in that pure copper having a content of between 99.0 and 99.9% residual impurities is inserted into the weld seam.

10. The method according to claim 1, characterized in that a copper alloy of the following composition is melted in the weld seam: Cu 41.0 to 99.9%, Sn 0 to 13.0%, Zn 0 to 38.0%, Mn 0 to 13.0%, Ni 0 to 1.5%, Fe 0 to 0.5%, Ag 0 to 1.0% and optionally impurities.

11. The method according to claim 1, characterized in that a copper alloy of the following composition is melted in the weld seam: Sn approx. 0.6 to 10%, Si up to 0.3%, Mn up to 0.3%, remainder Cu and optionally impurities.

12. The method according to claim 1, characterized in that a copper alloy of the following composition is melted in the weld seam: Cu 87 to 95%, Sn 5 to 13%, preferably Sn approx. 6.0%, in particular Sn approx. 12%, remainder being Cu in each case and optionally impurities.

13. The method according to claim 1, characterized in that a copper alloy of the following composition is melted in the weld seam: Cu 56.0 to 62.0%, Zn 38 to 44%, traces <1% of Si, Sn, Mn and Fe and optionally impurities.

14. The method according to claim 1, characterized in that a copper alloy of the following composition is melted in the weld seam: Cu 96.5 to 97.5%, Ni 2.5 to 3.5%, and, at most, 0.15% impurities.

15. The method according to claim 1, characterized in that a copper alloy of the following composition is melted in the weld seam: Cu 98.8 to 99.2%, Ag 0.8 to 1.2% and optionally impurities.

16. The method according to claim 1, characterized in that a copper alloy of the following composition is melted in the weld seam: Sn up to 1.5%, Mn up to 1.5%, Fe up to 0.5%, Si 2.4 to 4.0%, remainder Cu and optionally impurities of up to 0.5%.

17. The method according to claim 1, characterized in that a copper alloy of the following composition is melted in the weld seam: Si approx. 3.0%, Mn approx. 1.0%, Sn, Fe, Zn of approx. 0.1% in each case, remainder Cu and optionally impurities.

18. The method according to claim 1, characterized in that a copper alloy of the following composition is melted in the weld seam: Mn approx. 2.5%, Sn approx. 0.8%, remainder Cu and optionally impurities.

19. The method according to claim 1, characterized in that a copper alloy of the following composition is melted in the weld seam: Al 7.5 to 14.0%, Mn 1.7% at most, Fe 1.0% at most, remainder Cu and optionally impurities.

20. The method according to claim 1, characterized in that a copper alloy of the following composition is melted in the weld seam: preferably Al approx. 8.0% or Al approx. 10.0%, Fe approx. 1.0%, remainder being Cu in each case and optionally impurities.

21. The method according to claim 1, characterized in that a cooper alloy of the following composition is melted in the weld seam: Al approx. 7.5%, Mn approx. 1.7%, Fe approx. 0.7% or Al 12.0 to 14.0%, remainder being Cu in each case and optionally impurities.

22. The method according to claim 1, characterized in that a copper alloy of the following composition is melted in the weld seam: Mn up to 13.0%, Al up to 8.0%, Fe up to 2.5%, Ni up to 2.0%, remainder Cu and optionally impurities.

23. The method according to claim 1, characterized in that a plasma beam is used as the high-energy beam.

24. The method according to claim 1, characterized in that a laser beam is used as the high-energy beam.

25. The method according to claim 1, characterized in that an electron beam is used as the high-energy beam.

26. The method of claim 1, wherein the welded parts form a machine part, which machine parts are finished.

27. The method of claim 26, characterized in that the parts forming the machine part are assembled and welded together without edge preparation.

28. The method of claim 26 for machine parts associated with vehicle technology, in particular parts of the drive chain for an all-terrain and/or road vehicle, especially for machine parts provided with a toothed wheel work.

29. A machine part formed from at least two parts welded together, at least one of said parts being formed from one of the materials mentioned in claim 1, characterized by a remelted material having a high Cu content, preferably Cu>38%, with the weld seam having a cross-section dimension smaller than 10 mm×1.5 mm, preferably smaller than 6 mm×0.8 mm.

30. A machine part according to claim 29, characterized in that the two parts are supported against each other with at least one locating surface, preferably a press fit.

31. A machine part according to claim 30, characterized in that at least one of the parts is provided with finished precision surfaces such as an interlocking etc. prior to welding.
